(19) United States
(12) Patent Application Publication
(10) Pub. No.: US 2009/0277962 A1
(43) Pub. Date: Nov. 12, 2009

(54) ACQUISITION SYSTEM FOR OBTAINING SHARP BARCODE IMAGES DESPITE MOTION

(75) Inventor: Scott McCloskey, Minneapolis, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Homeywell International Inc., Morristown, NJ (US)

(21) Appl. No.: 12/501,874

(22) Filed: Jul. 13, 2009

Related U.S. Application Data
(63) Continuation-in-part of application No. 12/126,761, filed on May 23, 2008.
Application No. 12/126,761 is a continuation-in-part of application No. 12/421,296, filed on Apr. 9, 2009.
(60) Provisional application No. 61/052,147, filed on May 9, 2008.
(60) Provisional application No. 61/156,739, filed on Mar. 2, 2009.

(51) Int. Cl. G06K 7/10; G06K 9/40

(52) U.S. Cl. 235/462.01; 382/255

(57) ABSTRACT

A system for barcode acquisition having a camera with a flutter shutter. The flutter shutter may operate according to a pattern or code designed to accommodate parameters such as distance between the camera and a barcode, barcode type, velocity between the camera and the barcode, blur estimation base on barcode features, and other factors. The image from the camera may be de-blurred or decoded in accordance with the flutter shutter pattern or code. Several images may be captured for patterns or codes based on different parameters. These images may be de-blurred and the highest quality image may be selected according to barcode landmarks.

This present patent application is a continuation-in-part of U.S. patent application Ser. No. 12/126,761, filed May 23, 2008, entitled “Simulating a Fluttering Shutter from Video Data”; which claims the benefit of U.S. Provisional Patent Application No. 61/052,147, filed May 9, 2008, entitled “Simulating a Fluttering Shutter from Video Data”.

This present patent application is a continuation-in-part of U.S. patent application Ser. No. 12/421,296, filed Apr. 9, 2009, entitled “Method and System for Determining Shutter Fluttering Sequence”; which claims the benefit of U.S. Provisional Patent Application No. 61/156,739, filed Mar. 2, 2009, entitled “Method and System for Determining Shutter Fluttering Sequence” U.S. patent application Ser. No. 12/126,761, filed May 23, 2008, is hereby incorporated by reference. U.S. patent application Ser. No. 12/421,296, filed Apr. 9, 2009, is hereby incorporated by reference. U.S. Provisional Patent Application No. 61/052,147, filed May 9, 2008, is hereby incorporated by reference. U.S. Provisional Patent Application No. 61/156,739, filed Mar. 2, 2009, is hereby incorporated by reference.

The U.S. Government may have certain rights in the present invention. An applicable contract number may be W91CRB-09-C-0013. A sponsoring agency was the Army Research Labs/Biometrics Task Force.

### BACKGROUND

This invention pertains to image blur removal mechanisms. Particularly, the invention pertains to cameras and more particularly to flutter shutter cameras.

Related patent applications may include U.S. patent application Ser. No. 11/430,233, filed May 8, 2006, entitled “Method and Apparatus for Deblurring Images”; and U.S. patent application Ser. No. 11/429,694, filed May 8, 2006, entitled “Method for Deblurring Images Using Optimized Temporal Coding Patterns”; all of which are hereby incorporated by reference.

### SUMMARY

The invention is an optical scanner using a flutter shutter.

### BRIEF DESCRIPTION OF THE DRAWING

FIG. 1 is a diagram of that compares fluttering and traditional shutters;

FIG. 2a is a diagram of a setup for flutter shutter capture of barcodes in, for example, a test scenario or an assembly line;

FIG. 2b is a diagram for flutter shutter capture of a barcode using a portable handheld device;

FIGS. 3a, 3b and 3c are images of various patterns taken with a traditional shutter and flutter shutter with corresponding de-blurred images, and reference images;

FIG. 4 is a table of error and contrast measurements of the various patterns taken with a traditional shutter and flutter shutter with corresponding de-blurred images;

FIG. 5a shows captured and processed barcode images for a traditional shutter;

FIG. 5b shows captured and processed barcode images for a flutter shutter;

FIG. 5c shows a reference still image of the barcode referred to in FIGS. 5a and 5b;

FIG. 6 is a diagram of a high-level flow chart of operations depicting logical operational steps of an approach for simulating a fluttering shutter from video data;

FIG. 7 is a diagram of a high-level flow chart of operations depicting logical operational steps of an optimization approach for finding a shutter fluttering pattern that has several desired properties; and

FIG. 8 illustrates a high-level flow chart of operations depicting logical operational steps of an approach for determining a shutter fluttering sequence.

### DESCRIPTION

Image-based scanning of 2D barcodes is a growing area of application in many fields. Like most applications based on image sensing, the performance of the barcode reading system depends, in large part, on the quality of the acquired imagery. There are several tradeoffs that may be employed to optimize one aspect of image quality (optical blur, noise levels, motion blur, image resolution) at the expense of the other aspects. For virtually any image-based application, there are bounds outside of which useful imagery cannot be acquired. Broadly speaking, these bounds are related to the amount of illumination, the distance to the object being imaged, and the speed at which the object or camera moves during capture. Because of the above-mentioned tradeoffs, the increased tolerance to any of these three factors may be traded against in order to improve different aspects of image quality.

The present approach increases the applicability of image-based scanning of 2D barcodes by enabling the acquisition of high-quality imagery despite motion of either the camera or the printed barcode. Motion may arise in several applications of 2D barcode reading. When acquired from a hand-held device, for instance, movement of the operator's hand may reduce image sharpness due to motion blur. In a shipping distribution warehouse, though the camera may be mounted at a fixed location, motion blur may arise from objects moving along a conveyor belt.

The present approach enables the capture of high-quality 2D barcode imagery by acquiring an image using multiple-exposures in such a way that the appearance of a moving object/scene may be invertibly encoded at the spatial frequencies relevant to barcode recognition. The image, which contains the encoded appearance of the object, may be decoded by a non-traditional motion de-blurring approach based on the encoding scheme. Relative to the related art in blind deconvolution and traditional image processing, the present approach differs in that it uses multiple-exposure imagery and a co-designed de-blurring approach.

Relative to these factors, the present approach has two significant features. First, the exposure sequence used to capture the motion-encoded image may be chosen in such a way as to preserve only those spatial frequencies which are relevant to the recognition of the 2D barcode in question. This sequence may be chosen based on one or more of several criteria, including distance to the barcode, barcode type, and motion of the camera/barcode.

Second, the blur estimation step, which must be completed before decoding the moving object's appearance, may be performed with the assistance of barcode landmarks. Individual 2D barcode symbologies may have different start and stop patterns, or patterns that aid in localization and orientation. Given that such image features may be known to exist in the image, the blur estimation step can be performed by measuring the deformations of these patterns.

The present approach may have three main components. One may be pre-capture. One may compute a set of exposure sequences that can be used to optimally capture imagery at a certain distance, with a certain velocity, given a certain quantity of light, and for a specific set of critical spatial frequencies. Given (potentially incomplete) observations of these criteria, one may select the appropriate sequence for the given situation.

Another component may be capture. The chosen sequence may be used to modulate the exposure of the image sensor, and produce coded motion image. Still another component may be post-capture. The acquired image may be analyzed and processed. The analysis, as mentioned above, may determine the magnitude of motion blur in the image using a feature-based approach. The relevant barcode features, such as a start pattern, may be analyzed in the blurred image in order to estimate the blur extent. In addition, the exposure sequence used during the capture step may be provided in order to perform the blur estimation. Based on the blur estimate, the captured image may be processed in order to produce a sharp image of the barcode. Because the processing step is often sensitive to errors in the blur estimation, one may produce several deblurred images using different estimates. Out of this set of de-blurred images, one may select the one with the highest image quality using the barcode landmarks. This final image may then be sent to the barcode matching module.

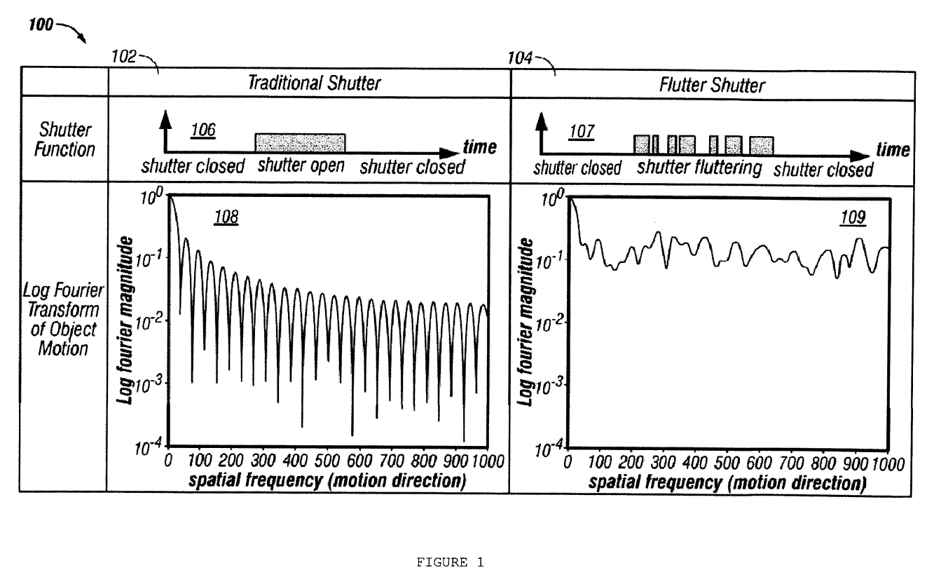

FIG. 1 is a diagram 100 that compares fluttering and traditional shutters. In order to properly motivate the use of a fluttering shutter, one may briefly review the image quality implications of motion blur as seen through a traditional open/closed shutter. In diagram 100, a column 102 includes data related to the use of a traditional shutter and column 104 illustrates data related to the use of a flutter shutter. A graph 106 depicts shutter timing with respect to the use of a traditional shutter. In column 104, a graph 107 illustrates shutter timing with respect to the use of a flutter shutter. A graph 108 is also illustrated in FIG. 1 with respect to column 102, while a graph 109 is depicted with respect to column 104. Graphs 108 and 109 illustrate data indicative of a log Fourier transform of the blur arising from object motion.

Column 102 of FIG. 1 illustrates the timing of a traditional shutter, along with the Fourier transform of the 1D blur in the direction of motion as depicted in graph 108. The Fourier transform data depicted in graph 108 shows that contrast is significantly muted at the middle and high spatial frequencies, and goes to zero at a number of spatial frequencies (the valleys in the Fourier transform). These spatial frequencies are lost when captured through a traditional shutter and post-processing the image cannot recover that information.

In the present approach, on the other hand, one may open and close the shutter according to the chosen exposure sequence during the capture of an image. Alternatively, one may select a sequence of weights that, when applied to a sequence of video frames and combined, produces an image with the same coded blur. Either method preserves image content at all spatial frequencies and may preserve virtually all frequencies at a nearly uniform level of contrast. Thus, column 104 of FIG. 1 (right column) depicts a simplified illustration of flutter shutter timing, along with the Fourier transform of motion blur associated with the shutter pattern. Comparing this to the Fourier transform associated with the traditional shutter (i.e., see graph 108), the flutter shutter (i.e., see graph 109) may preserve higher contrast at virtually all spatial frequencies and avoid lost frequencies.

There may be one-dimensional motion blur through a traditional shutter. The blur may be equivalent to convolution with a rectangle function point spread function (PSF). This blur may cancel image content at certain frequencies, such that the content cannot be recovered with post-capture image processing. Relative to traditional shutter blur, de-blurring techniques or approaches tend to significantly amplify noise.

A properly chosen flutter shutter in lieu of the traditional shutter may still produce a blurred image; however, the coded blur of the flutter shutter may carry more information. The flutter shutter may preserve spectral content at virtually all frequencies. The flutter shutter may also preserve higher contrast, requiring less amplification and thus resulting in less noise.

The present flutter shutter approach for barcode images may include the following items or steps. First, one may pre-compute the fluttering pattern to optimally preserve image content. Properties of barcode images, velocity, exposure time, blur estimation, and so forth, should be considered. Second, one may capture a flutter shutter image of a barcode moving relative to the camera. This motion may be due to the camera and/or barcode. The barcode may be on an object. Optionally, estimate velocity before capture and use the estimate to select a fluttering pattern.

Third, one may estimate motion blur from the captured flutter shutter image. The estimate may be derived from various information including knowledge of the fluttering pattern, prior knowledge of the target such as start/stop markers, appearance of active illumination, binary intensities, expected power spectrum, and so on, and outside knowledge, for example, an inertial monitoring unit.

Fourth, one may de-blur the captured flutter shutter image. Optionally, one may produce several de-blurred images to cover the error range of the blur estimation. Fifth, one may decode the de-blurred barcode image or images.

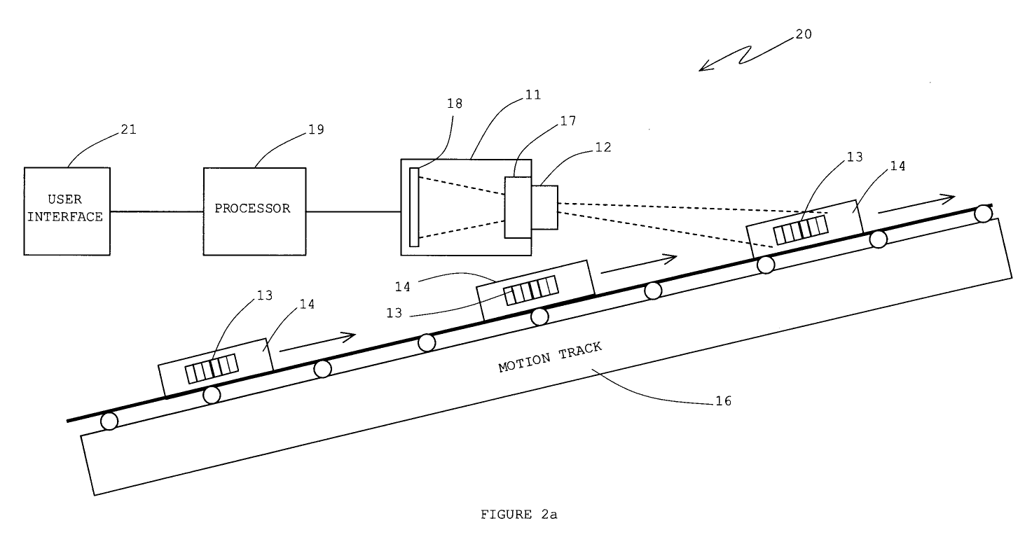

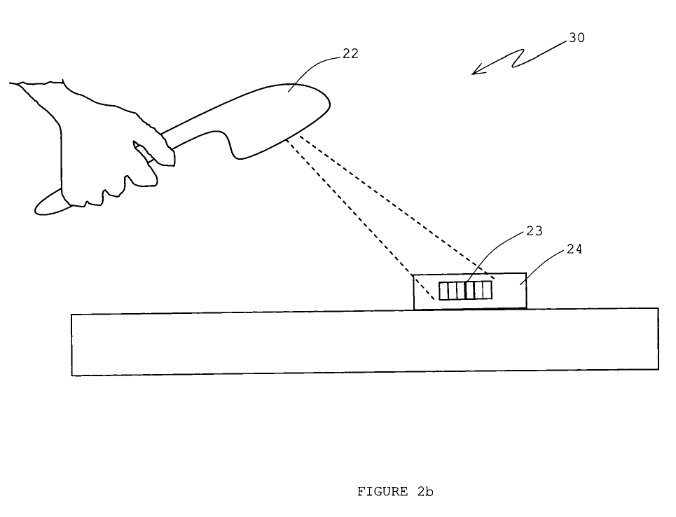

A setup 20 for flutter shutter capture of moving barcodes is shown in FIG. 2a, which may used to evaluate the invention during reduction to practice, or it could be similar to an assembly line set-up. A camera 11 may have a lens 12 focused so as to capture barcode labels 13 on passing objects 14 on a motion track 16. Proximate to lens 12 may be a flutter shutter 17 which permits an image of barcode 13 to be presented on a photosensitive image array 18. Flutter shutter 17 may be connected to a processor 19 for control. Array 18 may be connected to processor 19 for conveyance of a flutter shuttered image of the barcode 13 to processor 19 for processing and conveyance. A user interface 21 may be connected to processor 19 for monitoring and control of the barcode acquisition system setup 20.

Setup 20 may, for instance, have the motion track 16 provide a horizontal (lateral) motion to the objects 14 with the barcodes 13 at a speed of about 0.5 m/sec. relative to the camera 11. The exposure time of the shutter 17 may be about 4 ms. The distance between camera 11 and the target (i.e., a barcode currently being captured) may be about 0.45 m. Camera 11 may be a Point Grey Flea2™ camera (using IEEE DCAM v1.31 mode 5). The resolution of the images may be about 800×600 (where the images are cropped for presentation). The frame rate of the camera 11 may be about 15 frames per second. Examples of the targets 13 may include a 3.5 cm square Aztec™, a 3.5 cm square Data Matrix™, and a 5 cm long edge PDF417™. The parameters of setup 20 may have other values.

FIG. 2b is a diagram of a setup 30 which may be utilized in a grocery store check-out, a security point at a facility, a manufacturing area, or other application. Setup 30 shows flutter shutter capture of a barcode 23 on an item 24 using a portable handheld device 22. Either barcode 23 or capture device 22 or both may have movement resulting in blur.

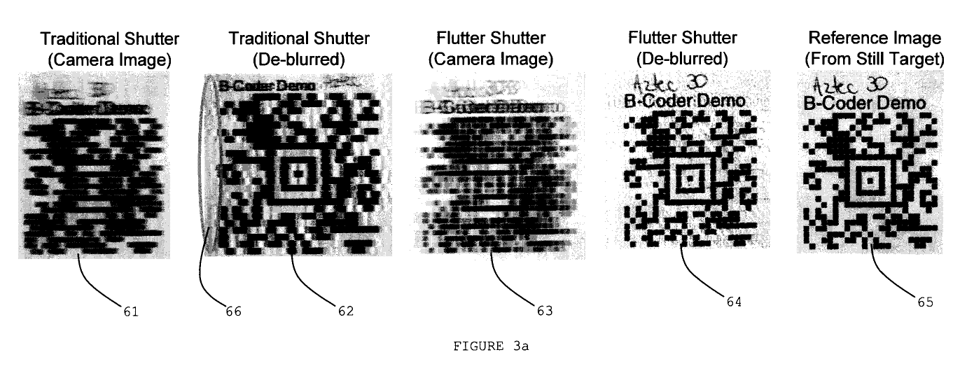

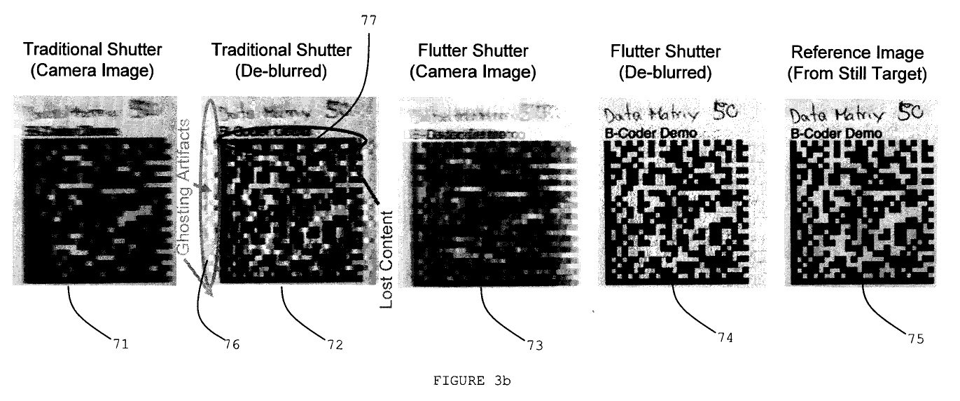

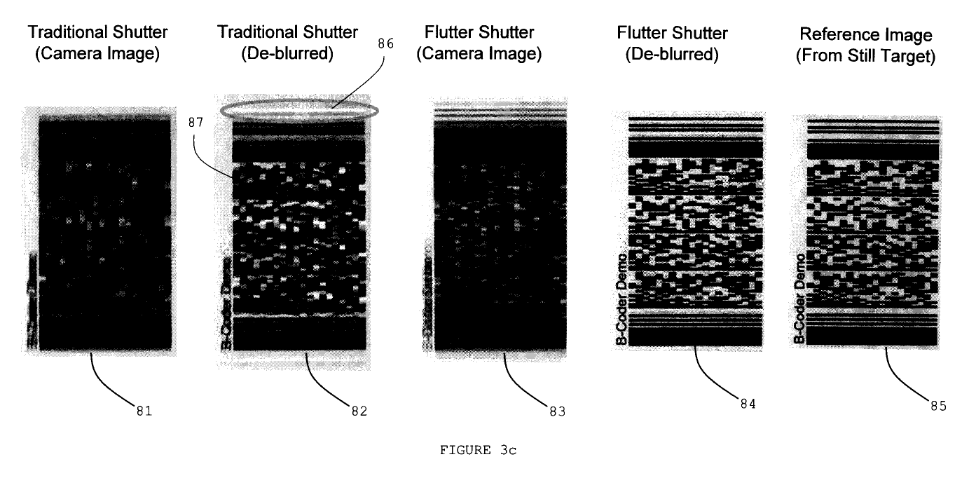

FIGS. 3a, 3b and 3c show examples of results of barcode capture with an arrangement, for example, like that of setup 20 or 30. FIG. 3a shows images 61-65 of the Aztec™ target. Image 61 is an image from a camera with a traditional shutter. Image 62 is a de-blurred image 61. Image 63 is an image from a camera with a flutter shutter. Image 64 is a de-blurred image 63. Image 65 is a reference image from a still target. Image 62 has ghosting artifacts 66.

FIG. 3b shows images 71-75 of the Data Matrix™ target. Image 71 is an image from a camera with a traditional shutter. Image 72 is a de-blurred image 71. Image 73 is an image from a camera with a flutter shutter. Image 74 is a de-blurred image 73. Image 75 is a reference image from a still target. Image 72 has ghosting artifacts 76 and lost content 77.

FIG. 3c shows images 81-85 of the PDF417™ target. Image 81 is an image from a camera with a traditional shutter. Image 82 is a de-blurred image 81. Image 83 is an image from a camera with a flutter shutter. Image 84 is a de-blurred image 83. Image 85 is a reference image from a still target. Image 82 has ghosting artifacts 86 and lost content 87.

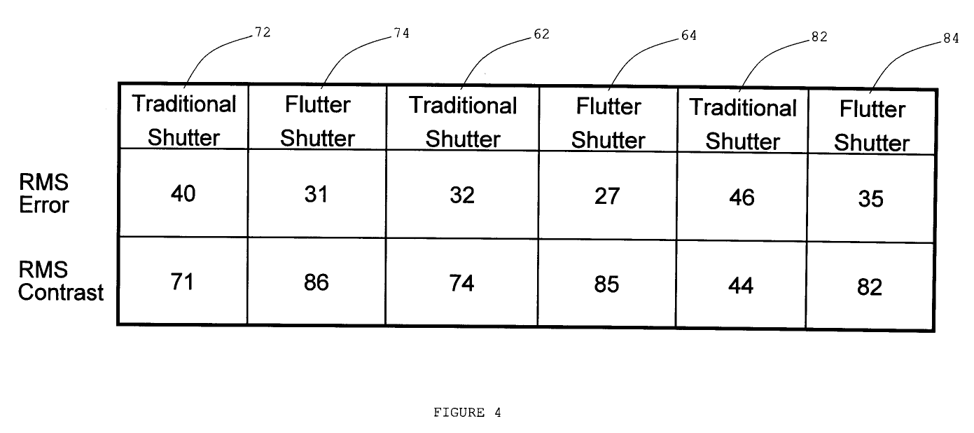

FIG. 4 shows a comparison table for the de-blurred images 62 and 64, 72 and 74, and 82 and 84, for traditional shutter and flutter shutter for the Aztec™ target, Data Matrix™ target and PDF417™ target, respectively, in terms of RMS error and RMS contrast. For the Aztec™ target, the RMS error is 32 for the traditional shutter and 27 for the flutter shutter with about 16 percent improvement for the flutter shutter. For the same target, the RMS contrast is 74 for the traditional shutter and 85 for the flutter shutter with about a 15 percent improvement for the flutter shutter.

For the Data Matrix™ target, the RMS error is 40 for the traditional shutter and 31 for the flutter shutter with about a 22.5 percent improvement for the flutter shutter. For the same target, the RMS contrast is 71 for the traditional shutter and 86 for the flutter shutter with about a 21 percent improvement for the flutter shutter.

For the PDF417™ target, the RMS error is 46 for the traditional shutter and 35 for the flutter shutter with about a 24 percent improvement for flutter shutter. For the same target, the RMS contrast is 44 for the traditional shutter and 82 for the flutter shutter, with a about an 86 percent improvement for the flutter shutter.

The average improvement in RMS error for the three noted targets is about 21 percent in favor of the flutter shutter. The average improvement in RMS contrast for the three targets is about 41 percent in favor of the flutter shutter. The overall average improvement in RMS error and contrast is about 31 percent in favor of the flutter shutter.

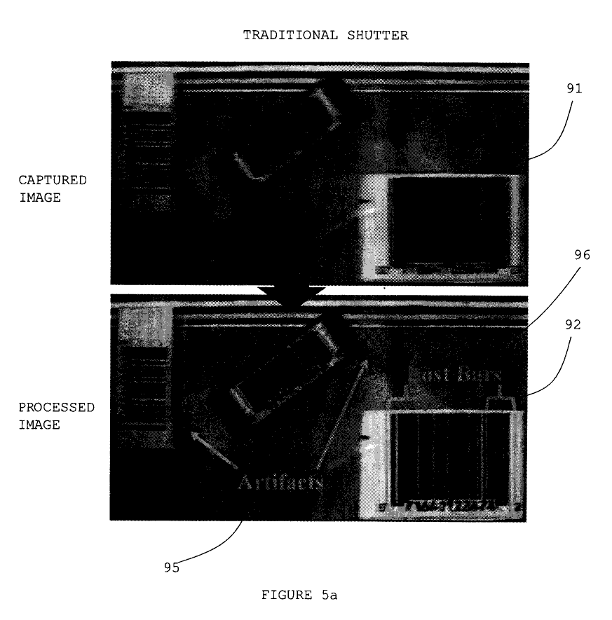

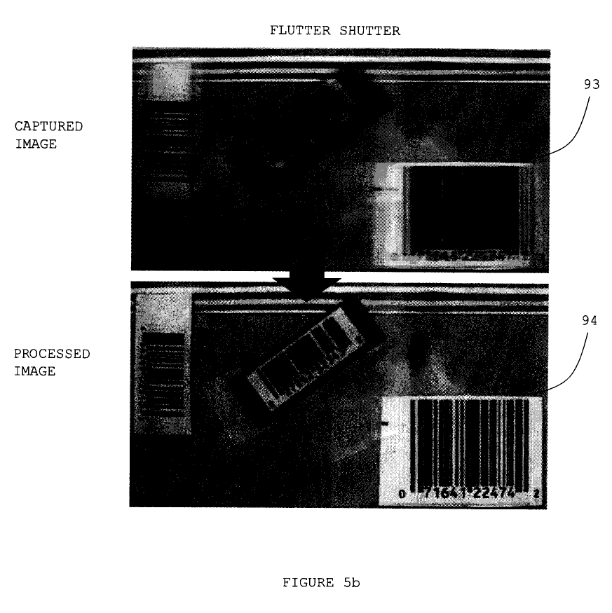

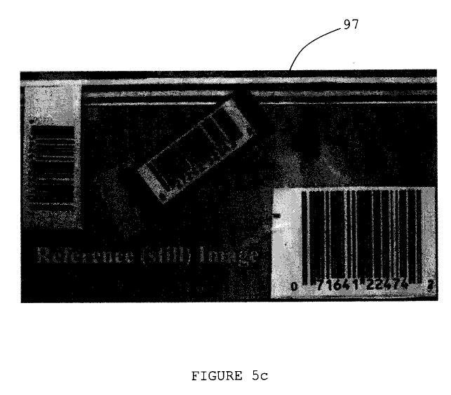

FIG. 5a shows a captured image 91 and the processed image 92 of a barcode for a camera with a traditional shutter. FIG. 5b shows a captured image 93 and the processed image 94 of a barcode for a camera with a flutter shutter. Artifacts 95 and lost bars 96 in the processed image 92 may be noted. The processed image 94 of the flutter shutter shows the barcode in much better detail than the processed image 92. FIG. 5c shows a reference image 97 of a still barcode. The images were captured with setup 20 shown in FIG. 2.

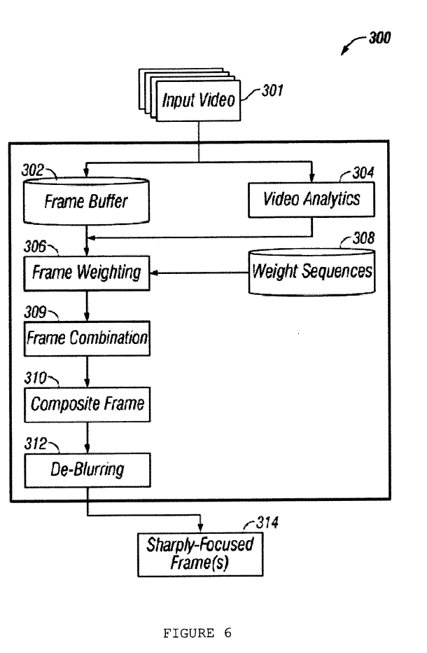

FIG. 6 illustrates a high-level flow chart of operations depicting logical operational steps of an approach 300 for simulating a fluttering shutter from video data. Approach 300 involves the generation and deblurring of composite images formed by adding a sequence of video frames, each scaled according to a sequence of weights. As indicated at block 301, video images may be provided. The operation described at block 301 generally involves capturing video frames using a standard camera. Next, as indicated at block 302, a frame buffer may be implemented to store a selection of recent video images provided via the operation illustrated at block 301. An operation involving video analytics, as described herein, may also be implemented, as depicted at block 304. A frame weighting operation may then be implemented as depicted at block 306, utilizing one or more weight sequences stored in a repository as indicated at block 308. The operation illustrated at block 306 generally involves scaling a subset of the captured video frames from the frame buffer (block 302) according to a sequence of weights to produce a plurality of scaled video frames thereof. The scaled video frames can then be combined at block 309 to generate one or more composite images (block 310) with coded motion blur. Thereafter, the composite image(s) may be processed at block 312 to produce a sharply focused image as illustrated at block 314.

Thus, by selecting an appropriate sequence of weights from the repository at block 308, the effects of a fluttering shutter may be synthesized in blocks 306 and 309, with the additional flexibility of being able to use negative and non-binary amplitudes. In addition, the video analytic functions (e.g., background subtraction, tracking, and occlusion detection) provided via the operation depicted at block 304 may be used to improve the results of the de-blurring. In particular, the use of background-subtracted frames in generating the composite image, as indicated at block 310, may assist in preventing background intensities from distorting the de-blurred image. Tracking information may be used to estimate the location and speed of moving objects in the scene, which can be used to generate a composite image with a fixed amount of motion blur. This may alleviate the need to estimate the direction and extent of motion blur from the coded image, errors in which can reduce the quality of the de-blurred image. Finally, occlusion detection may be utilized to select which frames should be combined to form the composite frame, choosing only those frames where the moving subject is visible.

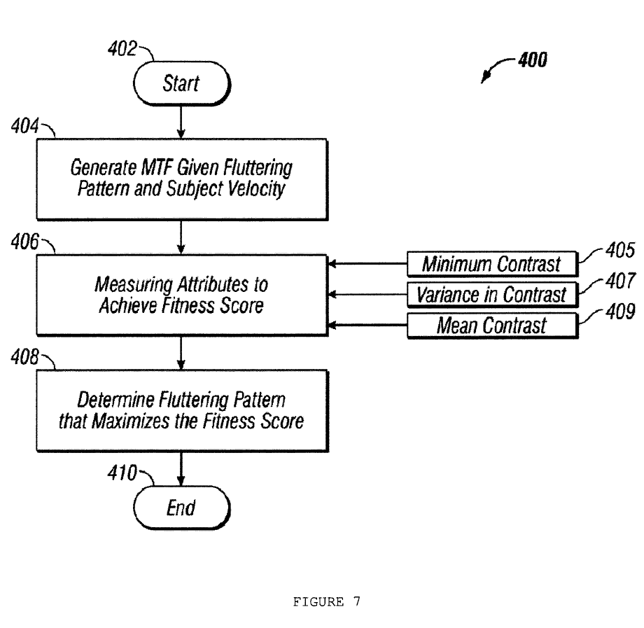

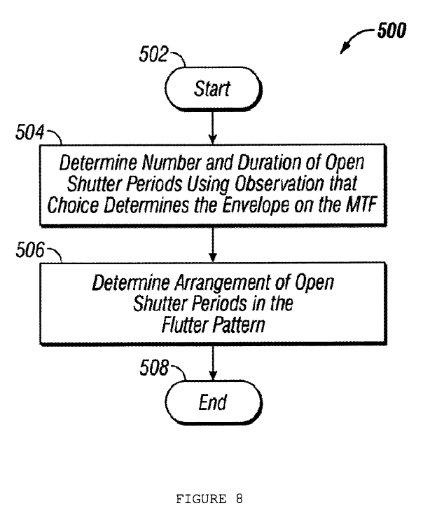

FIG. 7 illustrates a high-level flow chart of operations depicting logical operational steps of an approach 400. Note that the approach 400 of FIG. 7 and an approach 500 of FIG. 8, and other methodologies disclosed herein, may be implemented in the context of a computer-useable medium that contains a program product.

There may be an optimization approach for finding a shutter fluttering pattern that has several desired properties. The process may begin at block 402. Such properties can be expressed in the context of a fitness function. Given a fluttering pattern and a target subject's velocity, the equivalent modulation transfer function (MTF) may be generated at bock 404. Thereafter, as depicted at block 406, an operation may be processed for measuring three attributes, and, as indicated at block 408, may produce a fitness score. The three attributes may be the minimum contrast at block 405, the variance in contrast across spatial frequencies at block 407, and the mean contrast at block 409. An objective of approach 400 is to determine the fluttering pattern that maximizes the fitness score. The process may then terminate at block 410.

FIG. 8 illustrates a high-level flow chart of operations depicting logical operational steps of an approach 500 of determining a shutter fluttering sequence. Approach 500 may represents a further refinement to the general methodology of approach 400. As indicated by approach 500, the fluttering pattern may be completely specified by determining the number and duration of each open shutter period, and the start time of each such open shutter period. The approach may generally begin at block 502.

The instructions of approach 500 may perform the search for the near-optimal pattern by determining these two properties sequentially. Approach 500 may first determines the number and duration of open shutter periods using the observation that this choice determines the envelope on the MTF (i.e., an upper bound on the contrast at each spatial frequency), as indicated at block 504. Given a particular collection of open shutter periods that produces an envelope with good fitness, the second step, as indicated at block 506, may determine the arrangement of those open shutter periods in the flutter pattern. This may be achieved by creating an initial, naive arrangement, and then by modifying that arrangement in any one of a number of approaches (while preserving the validity of the sequence) that improve the fitness score. Given approaches that perform this modification, this second optimization step can be performed using a number of computational techniques. The approach may then terminate at block 508.

At a high level, the approaches 400 and 500 may receive as input two parameters which include the required exposure time (this may be the sum of the durations of the open shutter periods) and the subject velocity (measured in pixels per millisecond). Approaches 400 and 500 may incorporate hardware constraints by respecting the minimum allowable open shutter duration. The output of approaches 400 and 500 may be the fluttering pattern (for use with the camera control software), along with the equivalent MTF, point spread function (PSF), and fitness score (for analytic use).

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A method for barcode acquisition, comprising:
acquiring a coded blur image of a barcode;
estimating blur of the image; and
de-blurring the image of the barcode.

2. The method of claim 1, further comprising decoding the de-burred image of the barcode.

3. The method of claim 1, wherein the coded blur image is acquired with a multiple exposure, single image acquisition mechanism

4. The method of claim 1, wherein the coded blur image is acquired with a video mechanism.

5. The method of claim 4, further comprising synthesizing the coded blur image from a video of the video mechanism.

6. The method of claim 1, wherein:
the blur image is coded with coding sequences of a two step approach; and
the two step approach comprises:
determining a number and duration of open shutter periods using an observation; and
determining an arrangement of the open shutter periods in the flutter pattern.

7. The method of claim 6, wherein the coding sequences are effected to preserve barcode-relevant spatial frequencies.

8. The method of claim 1, wherein the estimating blur is effected with barcode features.

9. The method of claim 1, wherein the estimating blur is effected with barcode image statistics.

10. The method of claim 1, wherein the estimating blur is effected using hardware cues.

11. The method of claim 10, wherein hardware cues comprise an internal monitoring unit, projected aiming light, and/or other components.

12. The method of claim 1, wherein de-blurring comprises:
using a range of blur widths; and
choosing the best image.

13. A system for barcode acquisition, comprising:
a mechanism for acquiring a coded blur barcode image; and
a mechanism for estimating blur of the image;
a mechanism for de-blurring the image; and
a mechanism for decoding the de-blurred image.

14. The system of claim 13, wherein the mechanism for acquiring the coded blur image comprises a multiple exposure, single image acquisition device.

15. The system of claim 13, wherein:
the mechanism for acquiring a coded blur barcode image is a video device; and
the coded blur barcode image is synthesized from a video.

16. The system of claim 13, wherein:
the blur image is coded with coding sequences of a two step approach; and
the two step approach comprises:
determining a number and duration of open shutter periods using an observation; and
determining an arrangement of the open shutter periods in the flutter pattern; and
the coding sequences are effected to preserve barcode-relevant spatial frequencies.

17. The system of claim 13, wherein the estimating blur is effected with barcode features.

18. The system of claim 13, wherein the estimating blur is effected with barcode image statistics.

19. The system of claim 13, wherein:
the estimating blur is effected using hardware cues; and
the hardware cues comprise an internal monitoring unit, projected aiming light, and/or other components.

20. An acquisition system for obtaining sharp barcode images despite motion, comprising:
a camera for acquiring a coded blur image of a barcode;
an estimator for estimating blur of the image;
a device for de-blurring the image; and
a decoder for decoding the de-blurred image of the barcode; and
wherein the blurred image is coded with sequences determined by a number and duration of open shutter periods using an observation, and by an arrangement of the open shutter periods in the flutter pattern.
